(19) United States
(12) Patent Application Publication
(10) Pub. No.: US 2014/0259716 A1
(43) Pub. Date: Sep. 18, 2014

(54) SPACING AND AFFIXING GUIDE

(71) Applicant: Joshua M. Brandt, Charlestown, MA (US)

(72) Inventor: Joshua M. Brandt, Charlestown, MA (US)

(21) Appl. No.: 13/837,226

(22) Filed: Mar. 15, 2013

(51) Int. Cl. G01B 5/14

(52) U.S. Cl. CPC G01B 5/14
USPC 33/533

(57) ABSTRACT

A guide for uniform spacing and affixing of construction materials, comprising a guiding member and at least one spacing member.

### FIELD OF USE

This application relates to devices useful for the assembly or construction of decks or similar structures. More specifically, the present disclosure relates to devices useful in achieving uniformity of the spacing of components of a structure.

### BACKGROUND

Decks, and like structures, are often common in the housing, construction, and building industries. During construction a builder is often concerned with following steps to assemble a safe and appealing finished product. To accomplish this a builder may employ techniques to achieve goals such as ensuring an acceptable life span for the structure, promoting the structural integrity of the structure, and/or increasing the aesthetic appeal of the structure.

One objective, which when achieved advances these goals, is maximizing the uniformity of the spacing between the components of the structure, for example but not limited to, maximizing the spacing between the flooring or decking boards of a deck, as well as the spacing between the fasteners used to affix the components to the underlying structure. Improperly spaced components may not align properly and therefore become out of square, which may compromise the integrity of the structure. Improperly spaced components may also trap liquids, which may damage the component and therefore also compromise the integrity of the structure. Further, improperly spaced components are aesthetically unappealing.

Another goal, which when achieved, promotes life span, as well as, structural integrity, is establishing solid contact between the fasteners and the substrate to which they are affixed. With a deck, for example, it is critical that the deck fasteners align with the joists below. If the fasteners do not make contact, or make only partial contact, with the substrate below, the component will not be sufficiently affixed to the underlying structure. This misalignment may cause failure, which may result in an unsafe structure. Further, if the component is not properly affixed to the underlying structure, the component may buckle or deform due to use, weathering, or other forces, and become unsafe, which may compromise the underlying structure.

The diligence required to make certain that these goals are met when constructing these structures can be both time consuming and tedious. Decreasing the time to perform and assure these specifications are met can increase construction efficiency, reduce labor and overall cost, help increase structural longevity, as well as increase the consistency and reproducibility of construction methods.

### SUMMARY

In some embodiments, a spacing and affixing guide for use in construction, includes two or more components, which optionally may be integrally formed. A spacing member helps users to achieve consistent and uniform distance between two components, while a guiding member helps to allow alignment of fasteners at consistent and uniform positions. The spacing and affixing guide is a tool that can allow for the quick and consistent spacing of decking boards, while also providing for consistently aligned and uniformly spaced fasteners, and simultaneously indicating the location of the joist below the decking board which is being affixed. In some embodiments, the spacing and affixing guide could be utilized to affix the decking boards without any gap between the boards, while still allowing for consistently aligned and uniformly spaced fasteners.

In other embodiments, the spacing and affixing guide may include none, one, or any number, of the following components. The spacing and affixing guide may include a second spacing member. The spacing and affixing guide may include a handle, for increased manageability of the spacing and affixing guide. The spacing and affixing guide may include a rear pressure tab to apply further pressure to the spacing and affixing guide. The spacing and affixing guide may have a slide mechanism connecting one or both of the spacing members to the guiding member, to make the distance between the spacing members of the spacing affixing guide adjustable. The spacing and affixing guide may include a rear guiding hole to guide a fastener at an angle. The spacing and affixing guide may include a front guiding hole to guide a fastener at an angle. The spacing and affixing guide may include a guiding member of adjustable length, which would permit the spacing and affixing guide greater versatility on various dimensions of lumber. The spacing and affixing guide may include a spacing tab on the end of the guiding member to space secondary pieces or reverse the spacing and affixing guide. The spacing and affixing guide may further include one or more spacing sleeves to allow for the variability of the spacing dimension of the spacing and affixing guide.

### BRIEF DESCRIPTION OF THE DRAWINGS

FIG. 1 is a right side view of an exemplary embodiment of the spacing and affixing guide.

FIG. 2 is a top view of the guide of FIG. 1.

FIG. 3 is a rear view of the guide of FIG. 1.

FIG. 4 is an isometric view of the guide of FIG. 1.

FIG. 5 is a right side view of another exemplary embodiment of the spacing and affixing guide.

FIG. 6 is a top view of the guide of FIG. 5.

FIG. 7 is a rear view of the guide of FIG. 5.

FIG. 8 is an isometric view of the guide of FIG. 5.

FIG. 9 shows an exemplary embodiment of a spacing sleeve of the spacing and affixing guide as viewed from an isometric perspective.

### DETAILED DESCRIPTION OF THE PREFERRED EMBODIMENTS

As will be appreciated by one skilled in the art, the present disclosure may be embodied as a composition of matter, an apparatus, or a method of using the same.

Referring to FIGS. 1-4, one of the preferred embodiments of the spacing and affixing guide 10 includes a spacing member 11, which is positioned perpendicular, or substantially perpendicular to a guiding member 12.

Any two or more components of the spacing and affixing guide 10 may be integrally formed or they may be removably connectable to on or more adjacent components. When components are integrally formed, such integral formation may be achieved, for example, by molding or machining them from a larger piece of material. The substrate used to construct the spacing and affixing guide 10 may be a formable material such as, but not limited to, plastic or metal. Alternatively, the spacing member 11 and guiding member 12 may be created independently and the spacing and affixing guide 10 may be constructed of these individual smaller components at a later time.

The spacing member 11 can long enough to extend from the top plane of a deck board down vertically to below the plane of the top edge of the joist below the deck board. Thus, the spacing member 11 can be preferably long enough to be positionable such that it spans the distance from the top plane of the deck board to the mid point of the vertical dimension of the side of the joist below. The spacing member 11 can be deep enough to allow sufficient distance between the deck boards between which it is placed. This distance is preferably one-eighth of one inch (⅛″), but may be a smaller or larger dimension (e.g. depending an the requirements of the structure or building authority). The width of the spacing member 11 is preferably one and one-half inch (1.5″), but may be a smaller or larger dimension depending on the requirements of the structure or building authority (e.g. but should be less than the dimension of distance between the joists of the structure it is to be used on). The spacing member 11 has an inner edge 13, which contacts the vertical side of the joist below. The inner edge 13 may be flat as depicted, but also may be curved. The spacing member 11 may also have an portion of the member removed from lower corner closest to the inner edge 13, which will help to guide the spacing and affixing guide 10 into place during use.

The guiding member 12 is connected to the spacing member 11 which can be configured to contact the top of the decking boards. The guiding member 12 has a guiding edge 14 defined as the edge of the guiding member 12 which is located on the same side of the spacing and affixing guide 10 as the inner edge 13. The guiding edge can provide a consistent axis for the user to place a fastener along and affix the deck board to joist below. The guiding member 12 is oriented perpendicular, or substantially perpendicular, to the length of the spacing member 11 in a direction that is parallel, or substantially parallel to the surface of inner edge 13 of the spacing member 11. The guiding edge 14 of the guiding member 12 extends past the inner edge 13. This configuration allows for the guiding edge 14 to provide a reference axis and a consistent guide to indicate the joist below, thus allowing the user to easily visualize the placement of a fastener, which is used to affix the material to the substrate below when the inner edge 13 contacts the vertical face of the joist below. In some embodiments the extent to which the guiding edge 14 extends past the inner edge 13 is preferably three-quarters of one inch (0.75″), a dimension which will sufficiently allow for full contact between a fastener and the joist below. However, it is to be understood that this extension is not limited to being three-quarters of one inch (0.75″), and therefore it may be greater or less than three-quarters of one inch (0.75″). The inner edge 13 may, for example, extend slightly less to compensate for the width of the fastener to by used, thereby positioning the center of the fastener on the centerline of a joist. Further, the guiding member 12 or the guiding edge 14 may have one or more notches, or other indicating marks or features, added to guiding edge 14 or guiding member 12. These indicating marks assist in locating consistent and uniform positions for the fasteners. The indicators may be, for example, “tick marks”, a ruler, spaced notches or holes, or protrusions from the guiding edge 14 or guiding member 12. Further, the guiding member 12 may be configured to have points at which the guiding member may accept one or more various tools, these points could be static on the guiding member 12 or could be located on a sliding mechanism which would allow for continuous variability of the points. These configurations could manifest in notches created to accept the nozzle of a nail gun, screw gun, staple gun, caulking gun, and/or other construction devices. By following this procedure where each joist meets each board the fasteners are arranged in a continuous uniform line, which also align with the joists below. While the guide can create an aesthetically pleasing appearance, it also can also help to ensure that the fasteners have complete contact with the joist ensuring a maximal mechanical bond (e.g. as compared with situations when the fastener were to only partially contact the joist below).

When the spacing and affixing guide 10 is oriented such that inner edge 13 of the spacing member 11 contacts the vertical dimension of the joist and the guiding member 12 is positioned in a direction substantially parallel to the length of the joist resting on the material to be affixed to the joist, the guiding edge 14 can substantially indicate the midline of the joist below. For example, marks, notches, or other indication marks or protrusions on the guiding edge 14 or guiding member 12 can indicate reference points to position fasteners thereby giving uniformity of spacing and alignment with the midline of the joist below, as well as promote full contact between the fastener and the substrate. When used to attach decking boards to joists, the spacing and affixing guide 10 is oriented as above, with the spacing member 11 positioned between the two components to be spaced. The depth dimension of the spacing member 11 will provide the dimension of the space between the deck boards. In some examples two decking boards are consecutively affixed decking boards. In other examples the first board to be affixed may be spaced by positioning the spacing and affixing guide 10 between the board and any reference structure.

In some embodiments the spacing and affixing guide 10 includes a swivel mechanism connecting its parts. In this configuration the spacing and affixing guide 10 can permit the decking boards to be oriented at an angle to the joists below at angles of both 90° as well as angles greater and less than 90°. This can allow for use in less common applications of decking where, for example the decking is applied at a 45° angle to the joists.

Referring to FIG. 2, there is shown the embodiment of FIG. 1 of the spacing and affixing guide 10 as viewed from an aerial position, an overhead perspective or top view. A guiding member 12 and a guiding edge 14 are visible whereas the spacing member 11 and inner edge 13 of the apparatus are hidden from view, as compared to FIG. 1, positioned under the guiding member 12 and extending away from the viewpoint.

Referring to FIG. 3, there is shown the embodiment of FIG. 1 of the spacing and affixing guide 10 as viewed from a rear perspective. A spacing member 11 with an inner edge 13 is displayed vertically positioned under a guiding member 12 with a guiding edge 14, which is extending substantially perpendicular to the spacing member 11 in a direction away from the viewpoint.

Referring to FIG. 4, there is shown the embodiment of FIG. 1 of the spacing and affixing guide 10 as viewed from an isometric perspective, or off-axis view. As shown in FIG. 1, a spacing member 11 with an inner edge 13 shown connected to a guiding member 12 with a guiding edge 14.

Referring to FIG. 5, another exemplary embodiment of the spacing and affixing guide 110 includes a first spacing member 11 and a second spacing member 111, both of which are positioned perpendicular, or substantially perpendicular to a guiding member 112. The spacing members 11 and 111 are attached at a distance sufficient to allow the spacing and affixing guide to straddle a component (e.g. a decking joist) as described above, with the first spacing member 11 and the second spacing member 111 on different sides. This distance could be any distance, but is preferably one and one-half inches (1.5″), which is the common depth of a common 2× (“two by”) joist. Common dimensional lumber is often used in the construction of decks. Dimensional lumber is a term used for lumber that is finished/planed and cut to standardized width and depth specified in, commonly but not limited to inches. Examples of common sizes are 2×4, 2×6, and 2×8, the numbers denoting the width and depth in inches. The length of a piece of lumber may be specified in a different unit of measurement such as, but not limited to, feet. It is thus possible to find 2×4's that are, for example but not limited to, eight (8), ten (10), or sixteen (16) feet in length. Therefore, a piece of dimensional lumber by the name 2×4×8, which would be the “nominal dimensions,” would denote a piece of wood 2 inches deep, 4 inches wide, and 8 feet in length. However, the nominal dimensions will vary from the “actual dimensions” of the lumber because of various factors during the manufacturing process such as, but not limited to, the drying of the lumber, which can cause it to shrink, or in some instances expand. This is evidenced where a joist of nominal dimensions of 2×8 has actual dimensions of 1.5″×7.25″. While the nominal and actual dimensions vary, both sets of dimensions are well known in the art. Lumber Sizes, [online] 2010 [retrieved on Sep. 28, 2011] Retrieved from http://www.advantagelumber.com/sizes.htm; Dimensional Lumber [online] 2011 [retrieved on Sep. 28, 2011] Retrieved from http://homerenovations.about.com/od/glossary/g/dimlumber.htm. For a reference of common lumber used in building structures, the International Building Code, International Code Council (2009); the International Residential Code, International Code Council (2009); Lumber Sizes, [online] 2010 [retrieved on Sep. 28, 2011] Retrieved from http://www.advantagelumber.com/sizes.htm; or Dimensional Lumber [online] 2011 [retrieved on Sep. 28, 2011] Retrieved from http://homerenovations.about.com/od/glossary/g/dimlumber.htm., can be referenced and all are incorporated by reference in their entirety herein.

The guiding member 112 shown includes a spacing tab 115. The spacing tab 115 is located at the front of the guiding member 112, and is oriented substantially perpendicular to the guiding member extending down and running parallel to the first spacing member 11 and second spacing member 111. The spacing tab 115 is similar to the first spacing member 11 and second spacing member 111, in that it can serve to space the abutting course of decking boards. The spacing tab 115 shown further includes a front guiding hole 116, which functions to correctly position a fastener at an angle. This angle allows a fastener to enter the side of a deck board, exit the bottom of a deck board, and further enter a joist below. The front guiding hole 116 is angled down from the front of the spacing and affixing guide 110 traveling at a downward trajectory through the spacing tab 115 and exiting through the rear of the spacing tab 115 at a location lower than the entry point at the front of the spacing and affixing guide 110.

In some examples the spacing and affixing guide 110 includes a sliding mechanism to facilitate the adjustment of the distance between the spacing member 11 and spacing member 111. This can allow the spacing member 11 and spacing member 111 to fit over more than one joist (e.g. should the joist be doubled up next to one another, or placed along side one another in multiples, or larger, or smaller, cuts of lumber). This can be advantageous in instances where, for example, more, and/or less, structural support is required than can be accomplished by a single “two by” joist, or where, for example, the layout of the joists causes joists to abut, or be positioned closely together. Such an adjustable joint would also allow for the space between the spacing member 11 and spacing member 111 to accommodate non-traditional lumber dimensions. The spacing member 111 may be removably connectable to the spacing and affixing guide 110.

The sliding mechanism can be positioned laterally or medially. The sliding mechanism can operate to move only one of either spacing member 11 or spacing member 111 closer or further from the guiding edge 14; or, the sliding mechanism can operate to move both of spacing member 11 and spacing member 111 closer or further from the guiding edge 14. Further, there may be two sliding mechanisms that independently operate to move each of spacing member 11 and spacing member 111. The sliding mechanism may also operate to move both of spacing member 11 and spacing member 111 contemporaneously either closer or further from the guiding edge 14.

In some examples of the spacing and affixing guide 110 a pressure tab 113 can be attached to the rear and extend in a direction substantially parallel and opposite to the guiding member 112. The pressure tab 113 can allow for force to be applied to the spacing and affixing guide 110 from the rear of the spacing and affixing guide 110, it also can allow for force to be applied in a uniform manner to the spacing and affixing guide 110, by for example a hand or foot applying pressure to both the guiding member 112 and the pressure tab 113 simultaneously. The base of the pressure tab 113 can lie in the same plane as the base of the guiding member 112 which can facilitate the even placement of the spacing and affixing guide 110 on the decking boards. The pressure tab 113 may be removably connectable to the spacing and affixing guide 110.

In some examples of the spacing and affixing guide 110 a handle 114 can be attached to the spacing and affixing guide 110. The handle 114 can be attached to the spacing and affixing guide 110 near or at the point of connection between the first spacing member 11, the second spacing member 111, and the guiding member 112. The handle 114 can allow for easy gripping and positioning of the spacing and affixing guide 110. The handle 114 can take for example, but not limited to, the form of a tab, a “T” grip, a grip as depicted in FIG. 5 or any other form commonly employed in the art of handles. The handle 114 may be removably connectable to the spacing and affixing guide 110.

In some examples the spacing and affixing guide 110 can include a rear guiding hole 117, which can function to correctly position and angle a fastener in a similar fashion as the front guiding hole 116. This angle can allow a fastener to enter the side of a deck board and exit the bottom of a deck board where the fastener can further enter a joist below. The rear guiding hole 117 can be angled down from the rear of the spacing and affixing guide 110, can travel at a downward trajectory through spacing and affixing guide 110 and can exit through the front of either the first spacing member 11, the second spacing member 111, or at a point between the first spacing member 11 and the second spacing member 111, at a point lower than the entry point at the rear of the spacing and affixing guide 110. The rear guiding hole 117 can start in the rear of the first spacing member 11, second spacing member 111, or at a position located in between the first spacing member 11 and the second spacing member 111, alternatively the rear guiding hole 117 may start at the top of the pressure tab 113.

Referring to FIG. 6, there is shown the embodiment of FIG. 5 of the spacing and affixing guide 110 as viewed from an overhead perspective or top view. A guiding member 112 and second spacing member 111 are visible, whereas the first spacing member 11 of the apparatus is hidden from view, positioned under the guiding member 112 and extending away from the viewpoint. There is shown the handle 114, pictured horizontally, connected to the guiding member 112 and the pressure tab 113, extending towards the point of view.

Referring to FIG. 7, there is shown the embodiment of FIG. 5 of the spacing and affixing guide 110 as viewed from a rear perspective. The handle 114 is depicted above a pressure tab 113, which is extending towards the point of view. The first spacing member 11 and the second spacing member 111 are depicted under the pressure tab 113 and handle 114. The guiding member 112 is hidden from view, located behind the pressure tab 113, extending away from the point of view.

Referring to FIG. 8, there is shown the embodiment of FIG. 5 of the spacing and affixing guide 110 as viewed from an isometric perspective. The first spacing member 11 and the second spacing member 111 are shown extending downward, connected to the pressure tab 113, which is extending towards the viewpoint. The first spacing member 11, the second spacing member 111, and the pressure tab 113 are shown connected to the handle 114, which is extending upward. The first spacing member 11, second spacing member 111, pressure tab 113, and handle 114 are shown connected to the guiding member 112, which is extending away from the viewpoint.

Referring to FIG. 9, there is shown a spacing sleeve 311. The spacing sleeve 311 is formed to fit over spacing member 11 or spacing member 111. The spacing sleeve 311 functions to increase the depth of the spacing dimension of the spacing and affixing guide 310 without changing or swapping the first spacing member 11 or the second spacing member 111. The spacing sleeve 311 has inner dimensions, which will match the outer dimensions of the spacing member 11 or spacing member 111, while the outer dimensions of the spacing sleeve 311 may be a variety of depths, which will function to allow for the selection of different spacing dimensions. The spacing sleeve 311 may be a closed sleeve with a sealed bottom, but may also be open and not cover the entire first spacing member 11 or second spacing member 111. The spacing sleeve 311 only need be long enough to be placed over the first spacing member 11 or the second spacing member 111 and increase the spacing dimension between the decking boards or decking board and reference structure. The spacing sleeve 311 can also be envisioned to be piece of material that is able to be snapped on, or added to the first spacing member 11 or the second spacing member 111 to increase the dimension which spaces the component to be affixed.

The first spacing member 11, second spacing member 111, guiding member 112, spacing tab 115, pressure tab 113, handle 114, front guiding hole 116, or rear guiding hole 117, may also be formed as one piece. Any combination of the first spacing member 11, second spacing member 111, guiding member 112, spacing tab 15, pressure tab 113, handle 114, front guiding hole 116, or rear guiding hole 117, may be formed as on piece with any other component of the spacing or affixing guide 110. For example, the first spacing member 11 may be formed as one piece with the guiding member 112, or as one piece with the pressure tab 113 or as one piece with the handle 114, or individually, or as any sub-combination of the component parts.

Any of the previously mentioned components of this disclosure may be either permanently attached to one another or removably connectable to one another, meaning that the components may be temporarily, or transiently attached to one another. They may be attached to one another by a hinge, push tabs, spring loaded tabs, screw mechanism, swivel mechanism, sliding mechanism, weld, glue, epoxy, or any further method, either permanently or temporarily, or transiently attached for use. Even though it may be advantageous to have the components be separable, so that the two components may be separated or replaced in the event that one component fails, the components may be one piece, or permanently attached to one another.

Any and all patents, patent applications, publications, and references cited by this application are hereby incorporated by reference in their entirety. A plurality of embodiments of the present disclosure have been described; nevertheless, it will be understood by a person of skill in the art that various modifications may be made without departing from the spirit or scope of the following claims.

What is claimed is:

1. A spacing and affixing guide comprising:
a guiding member; and
a first spacing member removably connectable, or connected, perpendicular, or substantially perpendicular, to the guiding member.

2. An apparatus as in claim 1 further comprising a handle removably connectable, or connected, to the top of the apparatus of claim 1.

3. An apparatus as in claim 1 further comprising a pressure tab removably connectable, or connected, to the rear of the apparatus of claim 1.

4. An apparatus as in claim 1 further comprising a second spacing member.

5. An apparatus as in claim 1, wherein the distance between the spacing members is adjustable.

6. An apparatus as in claim 1, further comprising a rear guiding hole.

7. An apparatus as in claim 1, further comprising a front guiding hole.

8. An apparatus as in claim 1, further comprising a spacing tab.

9. An apparatus as in claim 8, further comprising a front guiding hole.

10. An apparatus as in claim 1, wherein the length of the guiding member is adjustable.

11. An apparatus as in claim 10, further comprising spacing tab.

12. An apparatus as in claim 11, further comprising a front guiding hole.

13. An apparatus as in claim 1, further comprising one or more spacing sleeves.
